(19) United States
(12) Patent Application Publication
(10) Pub. No.: US 2024/0273545 A1
(43) Pub. Date: Aug. 15, 2024

(54) A CONSUMER PRODUCT TYPE SOURCE ORIGIN META DATA IDENTIFICATION AND DATA PROCESSING SYSTEM

(71) Applicant: Christopher MOONEY, Melbourne (AU)

(72) Inventor: Christopher MOONEY, Melbourne (AU)

(21) Appl. No.: 18/251,589

(22) PCT Filed: Nov. 2, 2021
(86) PCT No.: PCT/AU2021/051288

§ 371 Date: May 3, 2023

(30) Foreign Application Priority Data
Nov. 3, 2020 (AU) 2020904003

(51) Int. Cl. G06Q 30/018; G06Q 30/0601; G06V 20/62; H04L 67/306

(52) U.S. Cl. CPC G06Q 30/018; G06Q 30/0639; G06V 20/62; H04L 67/306

(57) ABSTRACT

There is provided a system comprising a plurality of electronic devices, each electronic device comprising an image sensor and an image processing controller operably coupled thereto which obtains image data from a consumer product and which processes the image data to identify a type of the consumer product, an identification controller which retrieves meta data including source origin data according to the type of the consumer product; and a user interface controller which controls a user interface displayed by digital display to update the user interface according to the meta data.

### FIELD OF THE INVENTION

This invention relates generally to consumer product type source origin meta data identification and data processing system.

### SUMMARY OF THE DISCLOSURE

There is provided herein a consumer product type source origin meta data identification data processing system which is used to automatically identify source origin of consumer products and perform associated processing accordingly.

The system comprise a plurality of electronic devices, each comprising an image sensor in operable communication with an image processing controller which obtains image data from a consumer product in the field of view of the image sensor and which processes the image data to identify a type of the consumer product.

An identification controller retrieves meta data including source origin data according to the type of consumer product which may then be displayed on a user interface of a digital display of the electronic device.

The user may configure a user profile with a source origin array indicating origins (such as countries) from which the user does not wish to purchase products. As such, the system may determine whether the source origin obtained from the meta data of the identified type of consumer product is contained within the source origin array and provide an indication accordingly.

User interface may comprise a live field of view of the image data obtained by the image sensor and the controllers may augment the live field of view with the indication, such as by showing a translucent overlay of a product within boundaries thereof determined by image recognition.

The system may store consumer product data comprising consumer type identification data (which may be identified by name, manufacturer, brand, style, colour, and/or size obtained from a stock keeping unit (SKU)) and relational data relating to various types of consumer products. The relational data may comprise consumer product type categorisations or hierarchies thereof such as comprising a “baked beans” category and a “with tomato sauce” subcategory.

As such, when determining that the source origin of an identified type of consumer product is specified by the user is source origin array, the system may suggest alternative consumer product types using the relational data.

In embodiments, the consumer type identification data within the consumer product data may be stored in relation to location data representative of availability of locations of consumer products. As such, when the system identifies alternative consumer product types using the relational data, the system may further filter the alternative consumer product types according to a distance determined by the GPS receiver of the electronic device and the location data stored within the consumer product data. For example, the system may filter alternative consumer product types which are located more than 100 m away for example. In embodiments, users may use a user interface to indicate availability of alternatively suggested consumer product types such that the system is able to dynamically update the location availability data accordingly.

In further embodiments, short-range beacons (such as Bluetooth BLE beacons) associated with consumer products may be located in store which may transmit periodic transmissions which are received by a short-range communication interface of the electronic device. In accordance with this embodiment, when the system makes alternative product suggestions, the system may further filter the alternative product suggestions retrieved from the consumer product data depending on whether transmissions are received by the short-range communication interface indicative of whether alternative product suggestions are available in store. If so, the transmissions may be used to locate such products, such as by determining relative distances therefrom using received signal strength (RSSI) indications.

In embodiments, the electronic devices may comprise the consumer product data or at least a subset thereof with an internal storage to avoid round-trip queries to a server across a wide area network, including when mobile network availability is intermittent. Further in accordance with this embodiment, electronic devices may communicate with each other using short-range communications to update consumer product data of each other accordingly. In further manner, an electronic device may be permanently installed in store which broadcasts the consumer product data to other electronic devices of consumers within the store using short-range communications with updated and/or relevant consumer product data.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a consumer product type source origin meta data identification and data processing system in accordance with an embodiment.

### DESCRIPTION OF EMBODIMENTS

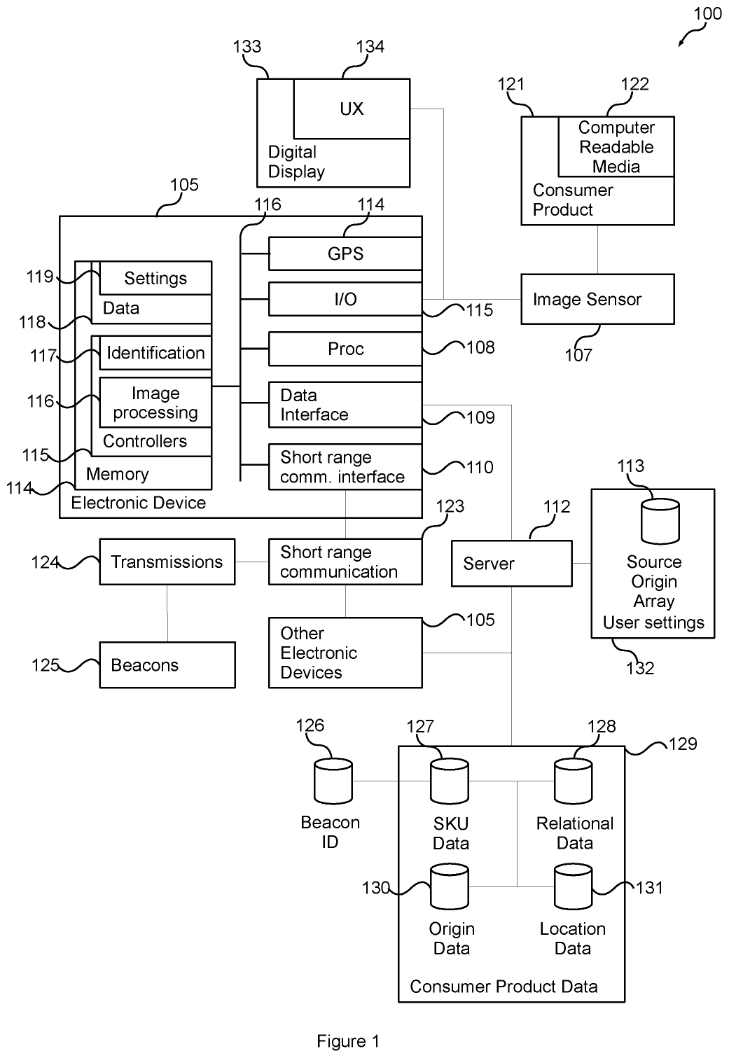

FIG. 1 shows a consumer product type source origin meta data identification and data processing system 100 in accordance with an embodiment. The system 100 comprises a plurality of electronic devices 105.

Each electronic device 105 comprises a processor 108 for processing digital data. In operable communication with the processor 108 across a system bus 116 is a memory device 114. The memory device 114 is configured for storing digital data including computer program code instructions and associated data 118. In use, the processor 108 fetches these computer program code instructions and associated data 118 from the memory device 114 for interpretation and execution of the computational functionality described herein.

The computer program code instructions may be logically divided into a plurality of computer program code instruction controllers, including an image processing controller 116 and an identification controller 117 as will be described in further detail hereunder.

Each electronic device 105 may further comprise an I/O interface 115 interfacing an image sensor 107. The image sensor 107 is in operable communication with the image processing controller 116.

The I/O interface 115 may further be in operable communication with a digital display device 133 which is controlled by the controller to display a user interface 134 thereon.

Each electronic device 105 may further comprise a GPS receiver 114 for determining a location of the electronic device 105.

Each electronic device 105 may further comprise a short-range communication interface 110 which may be controlled to send short-range communications 123 with other electronic devices 105. A short-range communication interface may further receive short-range transmissions 124 transmitted by beacons 125.

The short-range communication interface 110 may be a Bluetooth communication interface and the beacons 125 may be Bluetooth Low Energy (BLE) beacons 125. The short-range communication interface 110 may be configured for estimating a distance between the electronic device 105 and a beacon 125 in accordance with a received signal strength indication (RSSI) of the transmission 124.

The electronic devices 105 may be in operable communication with a server 112 across a wide area network, such as the Internet. The server 112 may maintain a database, including consumer product data, user profile data including user settings 132 and beacon IDs 126.

Each electronic device 105 may take the form of a communication device executing a specific software application which configures the communication device to operate in the specific manner described herein.

In use, the electronic device 105 is used to scan a consumer product 121 wherein the image sensor 107 thereof obtains image data of the consumer product 121. For example, a user may hold a consumer product 121, such as a tin of baked beans within a field of view of the image sensor 107 and operate the user interface 134 to capture the image data simultaneously. The user interface 134 may comprise a live field of view displaying the image data.

As alluded to above, the image processing controller 116 is in operable communication with the image sensor 107 so as to obtain the image data therefrom and to process image data to identify a type of consumer product accordingly.

The image processing controller 116 may identify the type of consumer product by using a text recognition so controller which extracts text from the image data and uses the text to identify the product. The image processing controller 116 may identify the type of consumer product in accordance with various image characteristics such as shape and/or colour. In embodiments, the image processing controller 116 may comprise a barcode recognition controller which reads a barcode of the consumer product 121.

Various ways of identifying a type of consumer product 121 may be used by the system 100. In an embodiment, letters and/or numbers that identify characteristics about each product, such as name, manufacturer, brand, style, colour, and size obtained from a stock keeping unit (SKU) may be used to identify a type of consumer product.

The identification controller 117 then retrieves meta data according to the type of consumer product identified by the image processing controller 116. The meta data may include origin data 130 indicating an origin of a type of consumer product. In embodiments, the identification controller 117 may query the database of the server 112 to obtain the origin data 130 therefrom.

The origin data 130 may represent a country. As such, for example, the identification controller 117 may, for example, identify that a type of consumer product is from China, or Australia or any other particular country.

The identification controller 117 may update the user interface 134 with the origin data 130. For example, where the user interface 134 comprises a live view of the image data obtained by the image sensor 107, the controllers 115 may augment the image data within the live view with the origin data 130. For example, as the user holds the 10 of baked beans in front of the image sensor 107, the controllers 115 may augment the live view thereof with the name of the country of origin.

If the server 112 database does not comprise origin data 130 for the type of consumer product (which may be identified using the SKU data 127 within the server 112 database), an entry may be created. In embodiments, the origin data 130 may be obtained from the electronic device 105. In one manner, the origin data 130 may be input by the user via the user interface 134.

In alternative embodiments, the image processing controller 116 comprises a text recognition sub controller which recognises text of a label of the consumer product 121 and which detects origin data therefrom. For example, image processing controller 116 may process image data of a label of the tin of baked beans to identify a country written thereon such as by matching a set of known countries or string matching a string such as “made in [country]” to identify the origin data 130. In embodiments, the text recognition sub controller or a barcode recognition sub controller of the image processing controller 116 may read a barcode from the consumer product 121 and recognises the origin data 130 therefrom, such as from a leading digit of a barcode printed thereon.

The system 100 may store user profile data including user settings 132. User settings may comprise a source origin array 113. For example, using the user interface 134, a user may configure the user settings 132 to specify that the user does not wish to purchase products from China, Pakistan or India. As such, using a drop-down selection field below, the user may control the user interface 134 to make the selections accordingly wherein the system updates the source origin array 113 in relation to the user profile data for the user accordingly.

As such, when the identification controller 117 identifies a source origin from the consumer product 121 meta data, the system 100 may determine whether the identified source origin is contained within the source origin array 113.

If the system 100 determines that the identified source origin is contained within the source origin array 113, the controllers 115 may update the user interface 134 to display an indication accordingly.

As alluded to above, the controllers 115 may be configured for augmenting a live view of the image data with such an indication.

In embodiments, the image processing controller 116 may determine boundaries of consumer product 121 within the field of view of the image sensor 107 and augment such indication within the boundaries. Indication may comprise a translucent overlay.

For example, where the user configures the source origin array 113 to include the countries China, Pakistan and India, where the identification controller 117 identifies the source origin of the tin of beans as being from China, the augmented display of the user interface 134 may augment the live view to show the tin of beans in a red translucent overlay. Alternatively, consumer products and a source origin not contained within the source origin array 130 may be shown normally, or differently, such as overlaid with a green translucent overlay.

The consumer product data 129 may comprise relational data 128 in relation to consumer product type identification data, shown as SKU data 127 in FIG. 1. The relational data 128 may relate consumer products by category or a hierarchy of categories. For example, a category may comprise a “baked beans” category and subcategories thereof may comprise “with tomato sauce”.

As such, where the system 100 determines that an identified consumer product type falls within the source origin array 113, the system 100 may select the related consumer product type from the consumer product data 129 using the relational data 128.

The controllers 115 may update the user interface 134 with an indication of the other type of consumer product selected.

As such, for example, where the system 100 identifies that the source origin of the tin of beans is in China and determines that the user has configured the source origin array 113 to include China, the system 100 may use the relational data 128 to select an alternative of consumer product having a different source origin country falling within the same category or categories. For example, the system 100 may use a relational data 128 to identify an alternative type of a tin of beans in tomato sauce which is sourced from Australia.

The consumer product data 129 may further comprise location data 131 stored in relation to the consumer product type identification data. When selecting alternative types of consumer products using the relational data 128, the system 100 may further filter the alternative types of consumer products according to proximity.

For example, each product type identification may be stored in relation to location data 131 representing the locations at which the consumer product type is available. Furthermore, the electronic device 105 may transmit a location thereof determined by the GPS receiver 114 thereof to the server 112 such that the server 112 can determine which alternative consumer product types related to the identified consumer product by the relational data 128 fall within a certain proximity radius.

The data 118 may comprise user configurable settings 119 which may specify the proximity radius. Alternatively, the proximity radius may be defined within the user settings 132. As such, the user may set that the user is willing to travel up to 500 m to obtain alternative product suggested by the system 100.

In embodiments, the system 100 is configured for updating the location data 131 in accordance with location data received from each electronic device 105. For example, the user may use user interface 134 to indicate whether the user is able to find an alternative consumer product type suggested by the system 100. If the user indicates that the user is able to find the alternative consumer product type, the system 100 may update the location data 131 with the location of the respective electronic device 105, thereby being indicative of the availability of the alternative consumer product type at the user's current location. As such, in this way, the system 100 may continually update the location data 131 according to availability of products which may in turn be used to filter alternative consumer product type suggestions according to availability within the proximity radius.

In embodiments, the consumer product data 129 or a subset thereof may be stored within the data 118 of each electronic device 105 such that the functionality described herein may be performed without necessarily querying the server 112 across the wide area network. In embodiments, electronic devices 105 may be configured to transmit consumer product update data to other electronic devices 105 using short-range communications 123. As such, for example, electronic devices 105 within a shopping aisle or the like may communicate with each other using short-range communications to update the consumer product data of each other accordingly. In embodiments, a retail outlet may comprise an electronic device 105 permanently installed thereon which communicates with consumer electronic devices 105 within the retail outlet. As such, each electronic device 105 uses consumer product data uses consumer product data 129 received from the permanently installed electronic device 105 within the retail outlet.

In embodiments, the system 100 may locate and/or determine availability of consumer products according to the aforedescribed transmissions 124. For example, various consumer products 121 may comprise beacons 125 associated therewith. For example, a beacon 125 may be installed on a shelf comprising a particular type of baked beans. Alternatively, the beacon 125 may be installed on a shelf comprising baked beans wherein the transmission 124 therefrom indicates the type of baked beans stacked on the shelf.

As such, when suggesting alternative consumer products using the relational data 128, the identification controller 117 may further filter the alternative consumer products depending on if transmissions 124 are received by the short-range communication interface 110 thereof indicating the availability of the suggested alternative within proximity. For example, the electronic device 105 may receive transmissions 124 indicating the availability of specific types of consumer products within a retail outlet. The transmissions 124 may indicate that a tin of baked beans in tomato sauce sourced from Australia is located within the retail outlet. However, the electronic device 105 does not receive transmissions 124 indicating that a tin of baked beans in tomato sauce sourced from New Zealand is available. As such, when identifying alternative consumer product including the tin of baked beans from Australia and New Zealand using the relational data 128, the controllers 115 may filter out the tin of baked beans from New Zealand because no short-range transmissions 124 of been received by the short-range communication interface 110 indicating availability thereof within the proximity of the electronic device 105.

In embodiments, when suggesting alternative consumer products using the relational data 128, the identification controller 117 may identify other products according to price. For example, where a consumer scans an Australian product and the users source origin array 113 and specifies that the consumer wishes to obtain products sourced in Australia, the identification controller 117 may suggest an alternative same or similar type of product also sourced within Australia.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

1. A system comprising a plurality of electronic devices, each electronic device comprising:
an image sensor and an image processing controller operably coupled thereto which obtains image data from a consumer product and which processes the image data to identify a type of the consumer product,
an identification controller which retrieves meta data including source origin data according to the type of the consumer product; and
a user interface controller which controls a user interface displayed by digital display to update the user interface according to the meta data.

2. The system as claimed in claim 1, wherein the user interface comprises a live view of the image data and wherein the user interface controller augments the image data with the meta data.

3. The system as claimed in claim 1, wherein the system stores user profile data, the user profile data comprising settings for a plurality of users, including an array of source origin data and wherein the identification controller detects whether the array of source origin data contains the source origin data identified by the identification controller.

4. The system as claimed in claim 3, wherein user interface controller displays an indication of whether the array of source origin data contains the source origin data.

5. The system as claimed in claim 4, wherein the user interface comprises a live view of the image data and wherein the user interface controller augments the image data with the indication of whether the array of source origin data contains the source origin data.

6. The system as claimed in claim 5, wherein the image processing controller identifies boundaries of the consumer product within the image data and wherein the user interface controller augments the image data within the boundaries.

7. The system as claimed in claim 6, wherein the user interface controller augments the image data with a transparent overlay layer.

8. The system as claimed in claim 3, wherein the system comprises a database comprising consumer product type identification data identifying a plurality of types of consumer products and consumer product type relational data relating various types of consumer products therein and wherein, when the identification controller detects that the array of source origin data comprises the source origin data in relation to an identified type of consumer product, the identification controller is configured for selecting alternative types of consumer product in accordance with the relational data.

9. The system as claimed in claim 8, wherein the relational data comprises a consumer product type categorisation.

10. The system as claimed in claim 9, wherein the product type categorisation comprises a hierarchy of categories and subcategories.

11. The system as claimed in claim 8, wherein the consumer product data comprises location data and wherein the identification controller is configured for filtering the alternative types of consumer products in accordance with the location data.

12. The system as claimed in claim 11, wherein the identification controller is configured for filtering the alternative types of consumer products in accordance with the location of the electronic device determined by a GPS receiver thereof.

13. The system as claimed in claim 8, wherein each electronic device comprises a GPS receiver which determines the location of the respective electronic device and wherein the system updates the location data according to the determined location of the respective electronic device.

14. The system as claimed in claim 11, wherein the identification controller is configured for selecting alternative consumer products in accordance with a distance threshold and a distance calculated in accordance with the location data.

15. The system as claimed in claim 8, wherein the consumer product data comprises beacon ID data and wherein each electronic device comprises a short-range communication interface configured for receiving short-range beacon transmissions

16. The system as claimed in claim 15, wherein the system is configured for filtering the alternative types of consumer product according to if a short-range transmission associated with a beacon ID thereof is received by the short-range communication interface.

17. The system as claimed in claim 16, wherein each electronic device is configured for locating an alternative consumer product in accordance with the received signal strength indication of the short-range transmission.

18. The system as claimed in claim 1, wherein the electronic devices are in operable communication with a server across a wide area network the server comprises a database comprising consumer product type identification data and wherein the identification controller queries the server to retrieve the meta data.

19. The system as claimed in claim 18, wherein the consumer product identification data comprises data fields of SKU data.

20. The system as claimed in claim 1, wherein the image processing controller comprises a text recognition sub controller and wherein the image processing controller recognises text within the image data.

21. The system as claimed in claim 20, wherein the image processing controller identifies the type of the consumer product according to the text.

22. The system as claimed in claim 21, wherein the system comprises a database comprising consumer product type identification data and wherein the identification controller queries the server to retrieve the meta data and, wherein, if the database does not comprise consumer product type identification data matching the type identified by the image processing controller, the server stores the type identified by the image processing controller in the database.
